(19) United States
(12) Patent Application Publication
(10) Pub. No.: US 2007/0136784 A1
(43) Pub. Date: Jun. 14, 2007

(54) COMMUNICATION TERMINAL APPARATUS

(76) Inventor: Masahiro Kisono, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/561,675

(22) Filed: Nov. 20, 2006

(30) Foreign Application Priority Data
Nov. 30, 2005 (JP) 2005-344797

(51) Int. Cl. H04L 9/00

(52) U.S. Cl. 726/1

(57) ABSTRACT

A disclosed communication terminal apparatus includes: a system control unit performing a plurality of device functions and a network communication function capable of communication via a network, wherein usage history information regarding each of the plural device functions is modified and transmitted in a semantic XML document of a predetermined format.

### BACKGROUND OF THE INVENTION

1. Field of the Invention

The present invention relates to a communication terminal apparatus including plural device functions and a network communication function capable of communication via a network.

2. Description of the Related Art

Conventionally, multi-function devices provided with plural functions of a copier, facsimile, scanner, printer, and the like have a network connection function, and are generally shared for use by plural users in an office.

If the multi-function devices connected to the network have a built-in Web server, the multi-function devices are configured to allow the users to refer to information on the device and to modify setting of the device by using a Web browser from a personal computer, a workstation, or the like. Further, in some cases, by using dedicated application software, it is possible to refer to information on the device or to modify setting of the device.

Meanwhile, data formats of so-called semantic XML documents such as RSS, Atom, and the like have been widely used as techniques for distributing updated information on websites. When such updated information on websites is described in accordance with these formats, it is possible for the users to efficiently obtain the updated information on websites by using dedicated reader software, a web application, or the like.

Patent Document 1 is well-known as RSS techniques applied to network-enabled devices. According to this invention, information on an edited device screen is distributed via RSS.

Further, Patent Document 2 discloses an invention by which updated information on galleries on websites is output via RSS.

Moreover, techniques of distributing updated information mainly as updated information on websites via RSS or Atom are generally known.

If provision of updated information is supported on websites through the RSS or Atom format, it is possible to efficiently collect information since only updated information is obtained, so that these techniques are very useful.

Patent Document 1: Japanese Laid-Open Patent Application No. 2005-228106

Patent Document 2: Japanese Laid-Open Patent Application No. 2005-196613

However, these formats are not created for network-enabled devices, so that data may not be distributed in a beneficial manner for users of the devices.

For example, it is difficult to discriminate and output information to each of applications (printer, scanner, facsimile, copier) provided by the device.

### SUMMARY OF THE INVENTION

It is a general object of the present invention to provide an improved and useful communication terminal apparatus in which the above-mentioned problem is eliminated.

A more specific object of the present invention is to provide a communication terminal apparatus that can provide information on usage history in each function of a device.

According to one aspect of the present invention, there is provided a communication terminal apparatus comprising: a system control unit performing a plurality of device functions and a network communication function capable of communication via a network, wherein usage history information regarding each of the plural device functions is modified and transmitted in a semantic XML document of a predetermined format.

According to another aspect of the present invention, the usage history information includes importance of information.

According to another aspect of the present invention, the usage history information includes information on consumables.

According to another aspect of the present invention, the information on consumables further includes contact information on an order destination for ordering relevant consumables.

According to another aspect of the present invention, the usage history information further includes a URL for obtaining information for handling error information included in the usage history information.

Thus, according to the present invention, the usage history information obtained from the apparatus is collected relative to each device function, so that the usage history information is very useful.

Other objects, features and advantage of the present invention will become more apparent from the following detailed description when read in conjunction with the accompanying drawings.

### BRIEF DESCRIPTION OF THE DRAWINGS

FIG. 1 is a block diagram showing an example of a configuration of a network-enabled multi-function device according to an embodiment of the present invention;

FIG. 2 is a block diagram showing an example of a configuration of a network-enabled multi-function device in terms of software;

FIG. 3 is a time chart showing an operation of a network-enabled device (network-enabled multi-function device according to the present embodiment) when a user requests updated information on the device;

FIG. 4 is a schematic diagram showing an example of a structure of updated information returned from a device in response;

FIG. 5 is a schematic diagram showing an example when updated information on a device is described in RSS;

FIG. 6 is a schematic diagram showing an example when updated information on a device is described in Atom;

FIG. 7 is a schematic diagram showing an example of RSS data in which information is categorized into information, error, warning, and the like in terms of importance;

FIG. 8 is a schematic diagram showing an example of RSS data to which information on the number of print sheets is added;

FIG. 9 is a schematic diagram showing an example of RSS data to which information on the number of print sheets and a paper size is added;

FIG. 10 is a schematic diagram showing an example of RSS data to which information on the number of print sheets, a paper size, and a print mode is added;

FIG. 11 is a schematic diagram showing an example of RSS data to which information on the number of print sheets, a paper size, a print mode, and a remaining amount of toner or ink is added;

FIG. 12 is a schematic diagram showing an example of RSS data to which information on the number of print sheets, a paper size, a print mode, a remaining amount of toner or ink, and an ID number of a toner or ink cartridge is added;

FIG. 13 is a flowchart showing a portion of processing for generating updated information on a device;

FIG. 14 is a schematic diagram showing an example of RSS data to which information on an ID number of a toner or ink cartridge is added;

FIG. 15 is a schematic diagram showing other example of RSS data; and

FIG. 16 is a schematic diagram showing an example of RSS data in which information is categorized into information, error, warning, and the like in terms of importance.

### DETAILED DESCRIPTION OF THE PREFERRED EMBODIMENTS

In the following, embodiments of the present invention will be described with reference to the accompanying drawings.

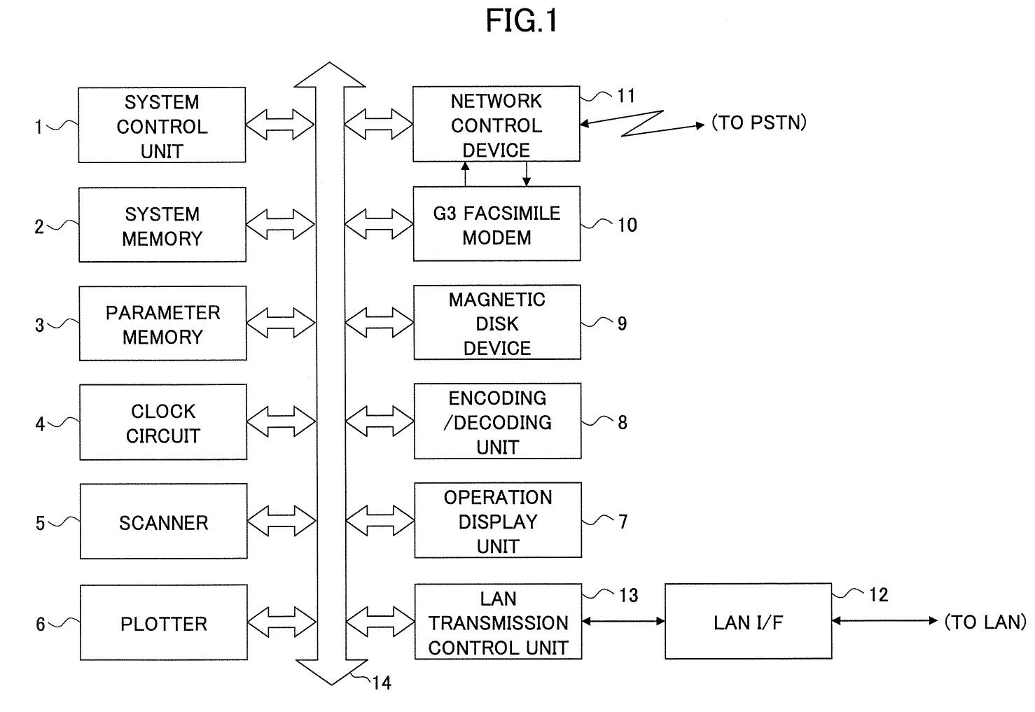

FIG. 1 is a block diagram showing an example of a configuration of a network-enabled multi-function device according to an embodiment of the present invention. The network-enabled multi-function device is provided with plural device functions (applications) of a copying function, network facsimile function, network printer function, scan to e-mail function, and the like.

In FIG. 1, a system control unit 1 is for performing various types of control processing such as device function processing including control processing for each portion of the network-enabled multi-function device, a copying function, a network facsimile function, a network printer function, a scan to e-mail function, and the like. A system memory 2 is for storing various types of data necessary when the system control unit 1 executes a control processing program and a processing program and constituting a work area of the system control unit 1. A parameter memory 3 is for storing various types of information specific to the network-enabled multi-function device. A clock circuit 4 is for outputting current time information.

A scanner 5 is for reading a manuscript image with a predetermined resolution. A plotter 6 is for outputting an image with a predetermined resolution. An operation display unit 7 is for operating the network-enabled multi-function device. The operation display unit 7 includes various types of operation keys and indicators.

An encoding/decoding unit 8 is for encoding image signals and decoding encoded image information into original image signals. A magnetic disk device 9 is for storing a large number of sets of encoded image information and various types of program files and data files.

A group 3 facsimile modem 10 is for realizing a modem function of a group 3 facsimile. The group 3 facsimile modem 10 is provided with a low-speed modem function (V.21 modem) for exchanging transmission procedure signals and a high-speed modem function (V.17 modem, V.34 modem, V.29 modem, V.27ter modem, and the like) mainly for exchanging image information.

A network control device 11 is for connecting the network-enabled multi-function device to public switched telephone networks (PSTN) and the network control device 11 is provided with an automatic calling and automatic answering function.

A local area network interface circuit 12 is for connecting the network-enabled multi-function device to a local area network (not shown in the drawings). A local area network transmission control unit 13 is for performing communication control processing of various types of predetermined protocol suites for exchanging various types of data with other data terminal device via the local area network. In addition, the local area network is connected to a global network (the Internet, for example) via a router device or the like not shown in the drawings. In accordance with this, the network-enabled multi-function device is capable of performing data communication as appropriate with each of other terminal devices connected to the global network.

An internal bus 14 connects the system control unit 1, system memory 2, parameter memory 3, clock circuit 4, scanner 5, plotter 6, operation display unit 7, encoding/decoding unit 8, magnetic disk device 9, group 3 facsimile modem 10, network control device 11, and local area network transmission control unit 13. Data is exchanged between each of these elements mainly via the internal bus 14.

Data exchange is directly performed between the network control device 11 and the group 3 facsimile modem 10.

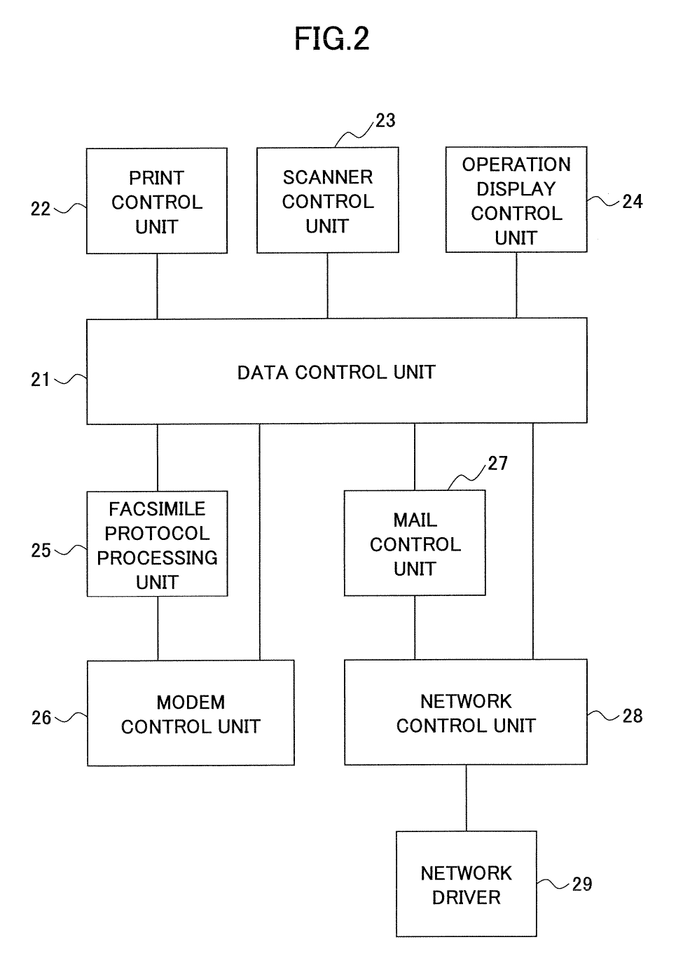

FIG. 2 is a block diagram showing an example of a configuration of the network-enabled multi-function device in terms of software.

In FIG. 2, a data control unit 21 is for performing various types of function control. A print control unit 22 is for performing control processing on a print function. A scanner control unit 23 is for performing control processing on an image data reading function. An operation display control unit 24 is for performing control processing on an operation display function performed using the operation display unit 7.

A facsimile protocol processing unit 25 is for processing a group 3 facsimile communication procedure. A modem control unit 26 is for controlling the group 3 facsimile modem 10.

A mail control unit 27 is for realizing an e-mail transmission/reception function. A network control unit 28 is for realizing various types of transmission control performed via the local area network. A network driver 29 is for controlling an operation of the local area network interface circuit 12.

In the present embodiment, data exchange among the terminal devices connected to the local area network (LAN) is basically performed in accordance with a combination of a transmission protocol to a transport layer (referred to as TCP/IP) and a communication protocol of an upper layer therefrom (referred to as a protocol suite). For example, when electronic mail data is exchanged, a communication protocol referred to as SMTP (Simple Mail Transfer Protocol) is applied as a communication protocol of an upper layer.

Further, communication protocols such as TCP/IP, SMTP, POP, and the like, data forms and data structures of electronic mail and the like are defined in RFC documents issued from IETF. For example, TCP is defined in RFC 793, IP in RFC 793, SMTP in RFC 821, forms of electronic mail in RFC 822, RFC 1521, RFC 1522 (MIME (Multipurpose Internet Mail Extension) format), and the like.

Further, HTTP is an acronym of “HyperText Transfer Protocol” and is a protocol used to realize what is called WWW (World-Wide Web). Usually, data is exchanged on TCP (port number: 80). For example, in accordance with commands such as GET, POST, and the like, a web browser operating on a workstation device or the like specifies processing to an HTTP server of the network-enabled multi-function device. In response, an XML (Extensible Markup Language) file, an HTML (HyperText Markup Language) file, or an image file is transmitted from the HTTP server. In the present embodiment, as will be described later, it is possible to provide a client with RSS information, Atom information, and the like as a semantic XML document.

Further, XML is defined in W3C (standard-setting organization for WWW techniques) recommendations. The XML is applied to the Internet by simplifying SGML (ISO/IEC 8879: 1986). The XML is different from HTML in that arbitrary tags can be used. In addition, it is possible to describe data and processing (layout, namely, design) separately.

The semantic XML refers to a file format for realizing functions of semantic Web techniques realized in XML. Examples based on RDF (Resource Description Framework) include RSS (Rich Site Summary 1.0 and Really Simple Syndication 0.9 to 2.0). In addition, Atom realizes the same functions as RSS.

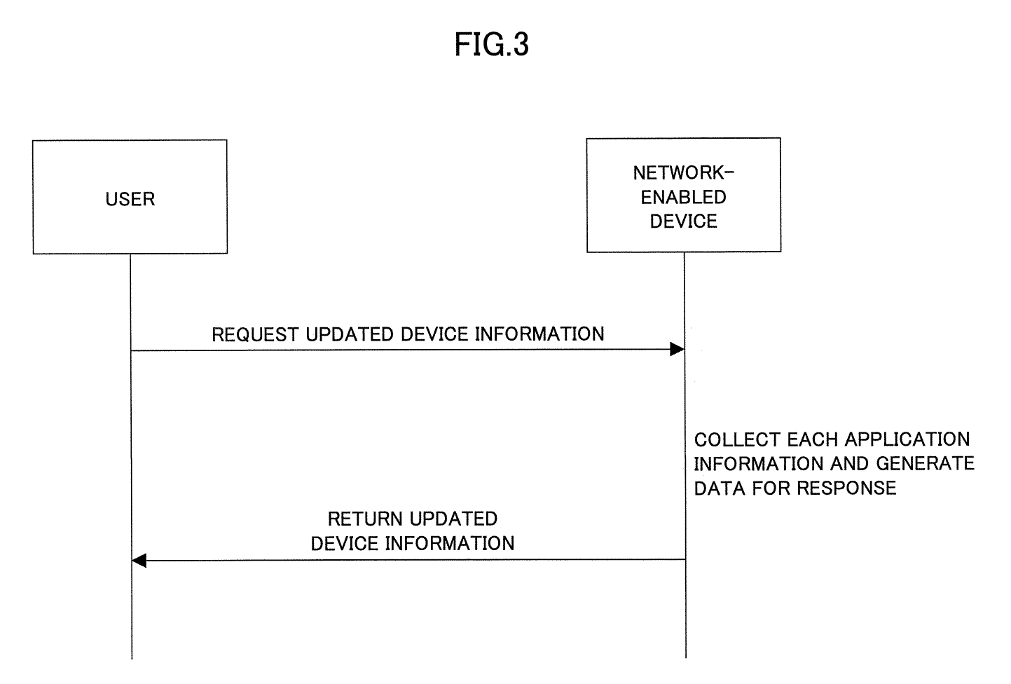

FIG. 3 is a time chart showing an operation of a network-enabled device (the network-enabled multi-function function device according to the present embodiment) when a user requests updated information on the device.

The user makes a request from software of a personal computer or the like to the network-enabled device to transmit updated information. Upon receiving the request, the network-enabled device generates data to transmit to the user as a response.

The network-enabled device selects information to be transmitted to the user from information on events, logs, and errors generated in each of applications (printer, scanner, facsimile, copier, and the like) operating on the network-enabled device and prepares data in accordance with a predetermined format. When the data is prepared, the network-enabled device transmits the response to the user requesting updated information. Preferably, the request and response of updated information are performed via the HTTP protocol, for example.

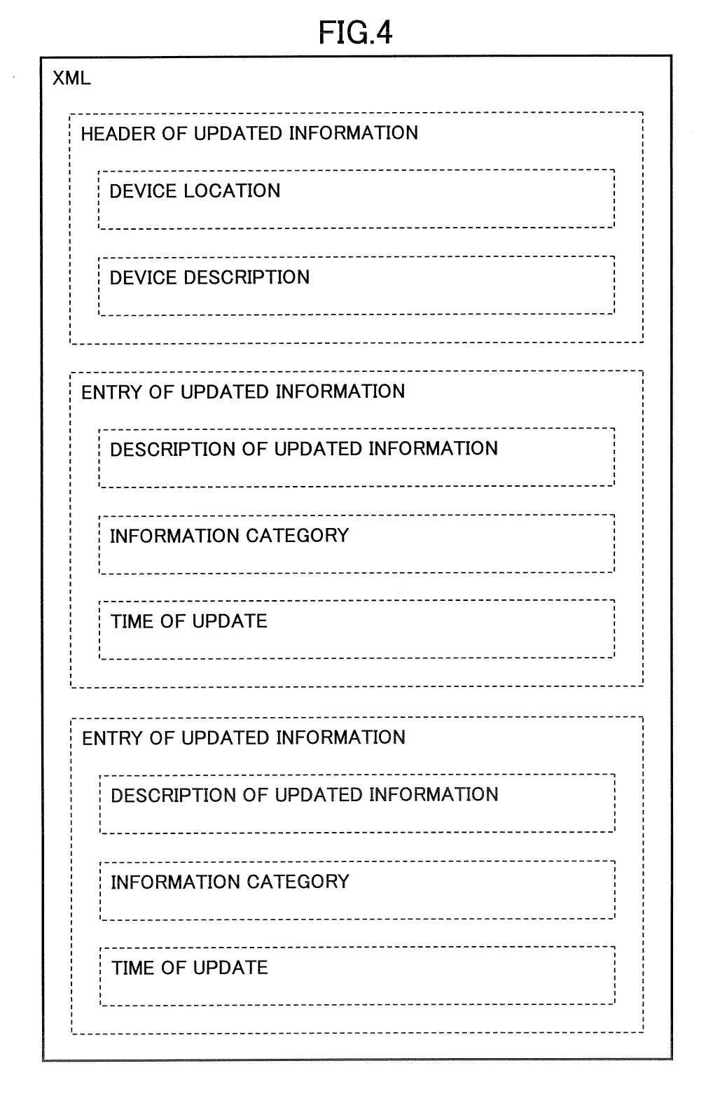

FIG. 4 is a schematic diagram showing an example of a structure of updated information transmitted from the device as a response. In many cases, XML is used as means to represent structured data, so that data structured in XML is schematically shown in the example.

In updated information header tags, general information on the updated information returned from the device is included. For example, in device location tags, an URL of the Web server device built in the device may be included. In device description tags, description of the device returning the updated information may be included.

In updated information entry tags, the information on events, logs, errors, and the like managed in the device is included. Plural items may be used as updated information entries. In FIG. 4, two entries are shown in the example. In updated information description tags, information in a human-understandable format representing contents of an entry is included. In information category tags, category information in each entry is included. For example, it is possible to categorize each of applications into a printer, scanner, facsimile, copier, and the like for example.

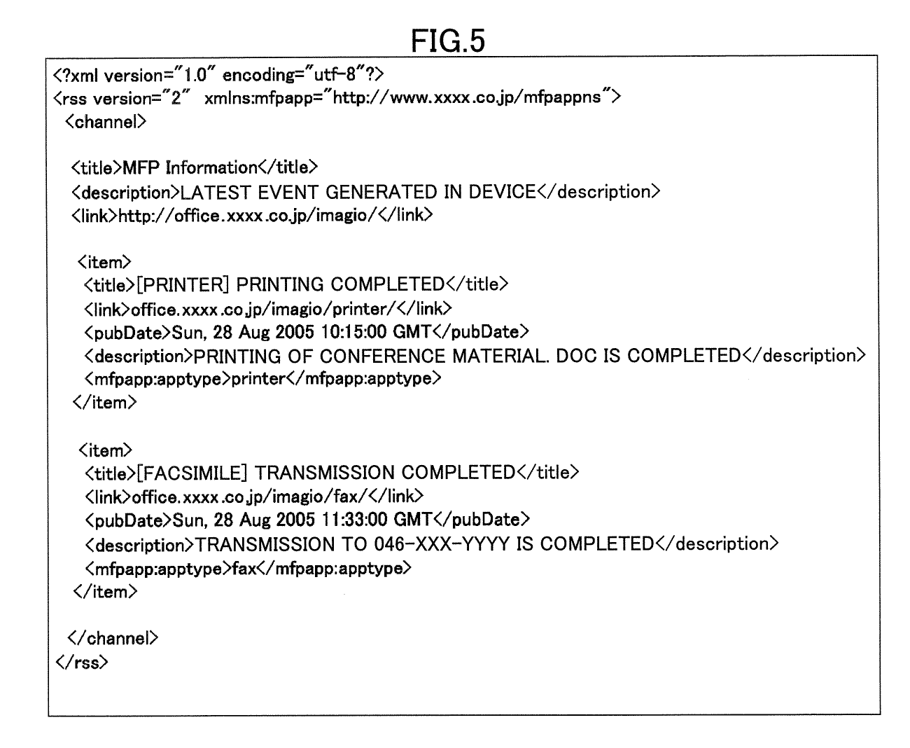

FIG. 5 is a schematic diagram showing an example when updated information on the device is described in RSS.

In FIG. 5, the example shows a case where a unique name space is used with an expanded function of RSS so as to represent the category information in each application. In this format, other elements are created in accordance with a standard RSS (RSS 2.0 in this example)

When the user receives RSS data in such a format as a response, it is possible to confirm the updated information on the device using software for processing RSS data.

Further, with the use of software capable of interpreting category information in each application defined in the unique name space, it is possible to judge which application the information of each entry of the updated information belongs to.

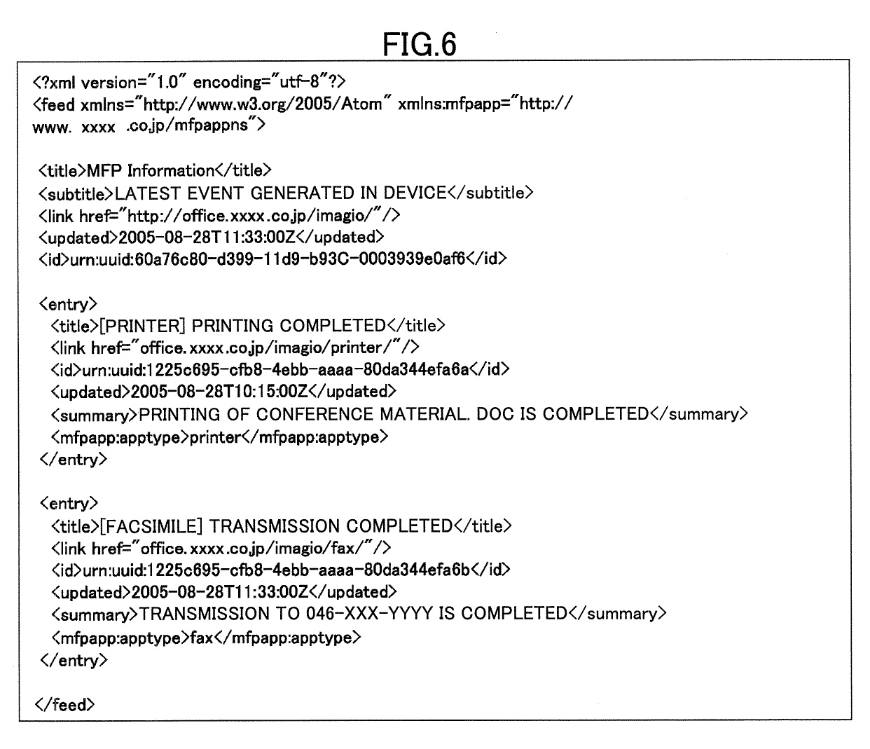

FIG. 6 is a schematic diagram showing an example when the updated information on the device is described in Atom.

The example in FIG. 6 shows a case where a unique name space is used so as to represent category information in each application. In this format, other elements are created in accordance with a standard Atom (Atom 1.0 in this example).

When the user receives Atom data in such a format as a response, it is possible to confirm the updated information on the device using software for processing Atom data.

Further, with the use of software capable of interpreting category information in each application defined in the unique name space, it is possible to judge which application the information of each entry of the updated information belongs to.

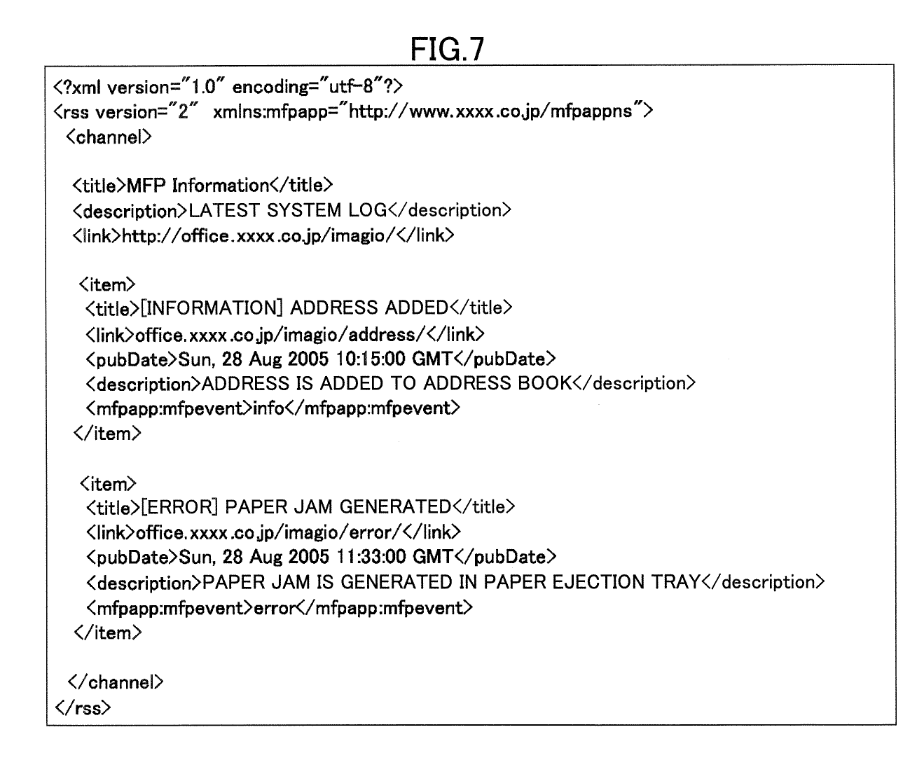

FIG. 7 is a schematic diagram showing an example of RSS data in which information is categorized into information, error, warning, and the like in terms of importance.

A structure of data in FIG. 7 is the same as in FIG. 5. In FIG. 7, tags for indicating importance of information (mfpapp:mfpevent in this case) are added in the name space.

When the user receives RSS data in such a format as a response, it is possible to confirm the updated information on the device using software for processing RSS data.

Further, with the use of software capable of interpreting the tags for indicating importance of information defined in the unique name space, it is possible to judge the importance of information in each entry of the updated information.

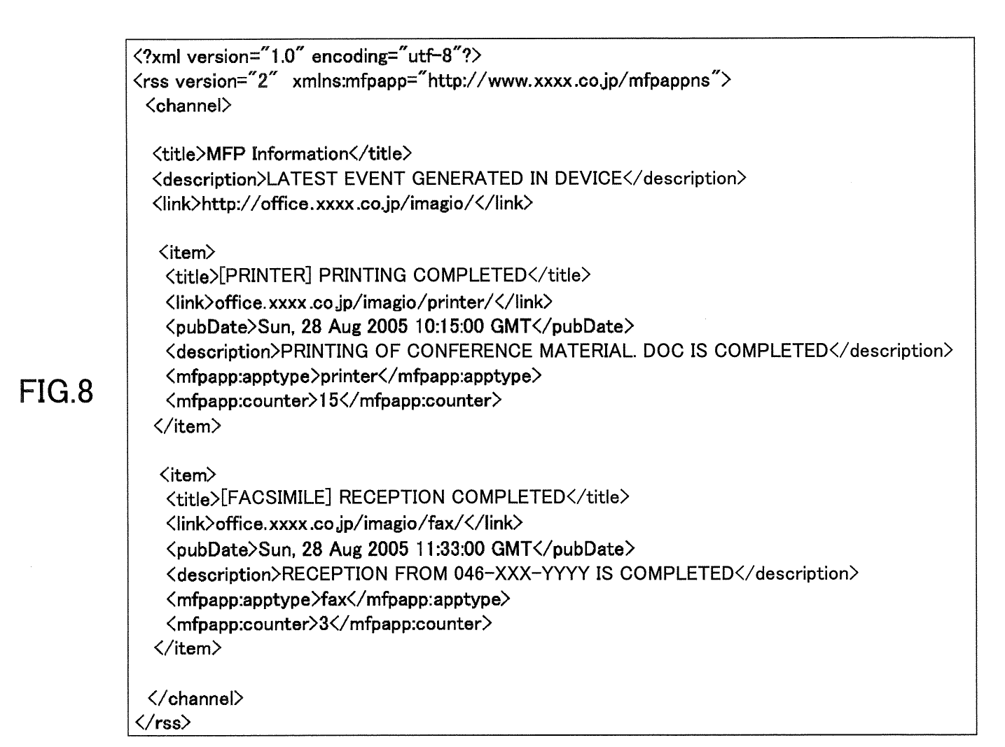

FIG. 8 is a schematic diagram showing an example of RSS data to which information on the number of print sheets is added.

A structure of data in FIG. 8 is the same as in FIG. 5. In FIG. 8, tags for indicating the number of print sheets (mfpapp:counter in this case) are added in the name space. The example shows cases when a document is printed on a printer and when printing is performed upon receiving a facsimile message.

When the user receives RSS data in such a format as a response, it is possible to confirm the updated information on the device using software for processing RSS data.

Further, with the use of software capable of interpreting the tags for indicating the number of print sheets defined in the unique name space, it is possible to judge the number of print sheets in each entry of the updated information.

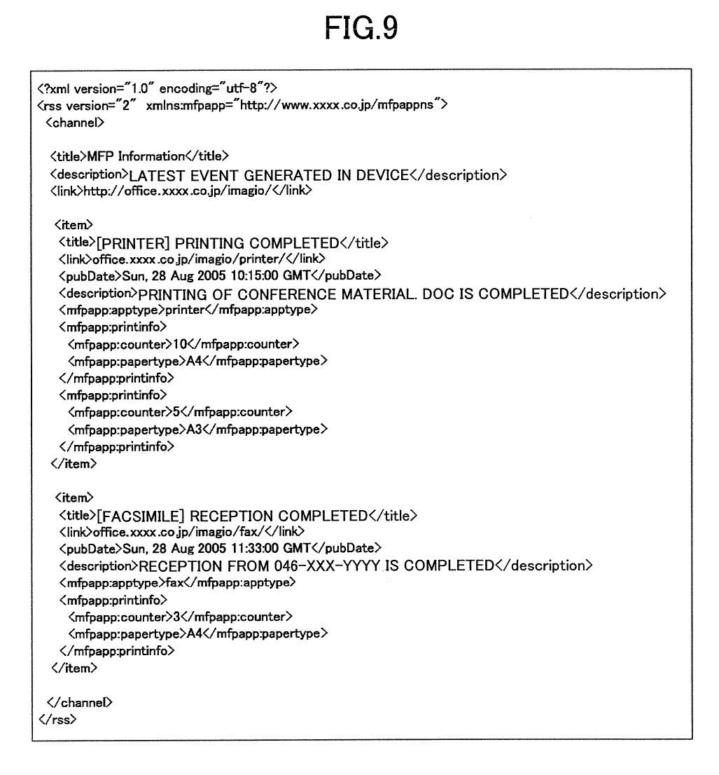

FIG. 9 is a schematic diagram showing an example of RSS data to which information on the number of print sheets and a paper size is added.

A structure of data in FIG. 9 is the same as in FIG. 5. In FIG. 9, tags for indicating print information (mfpapp:printinfo and mfpapp:papertype in this case) are added in the name space.

Each set of tags indicates the print information or the paper size. The example shows cases when a document is printed on a printer and when printing is performed upon receiving a facsimile message.

When the user receives RSS data in such a format as a response, it is possible to confirm the updated information on the device using software for processing RSS data.

Further, with the use of software capable of interpreting the tags for indicating the number of print sheets and the paper size defined in the unique name space, it is possible to judge the number of print sheets and the paper size in each entry of the updated information.

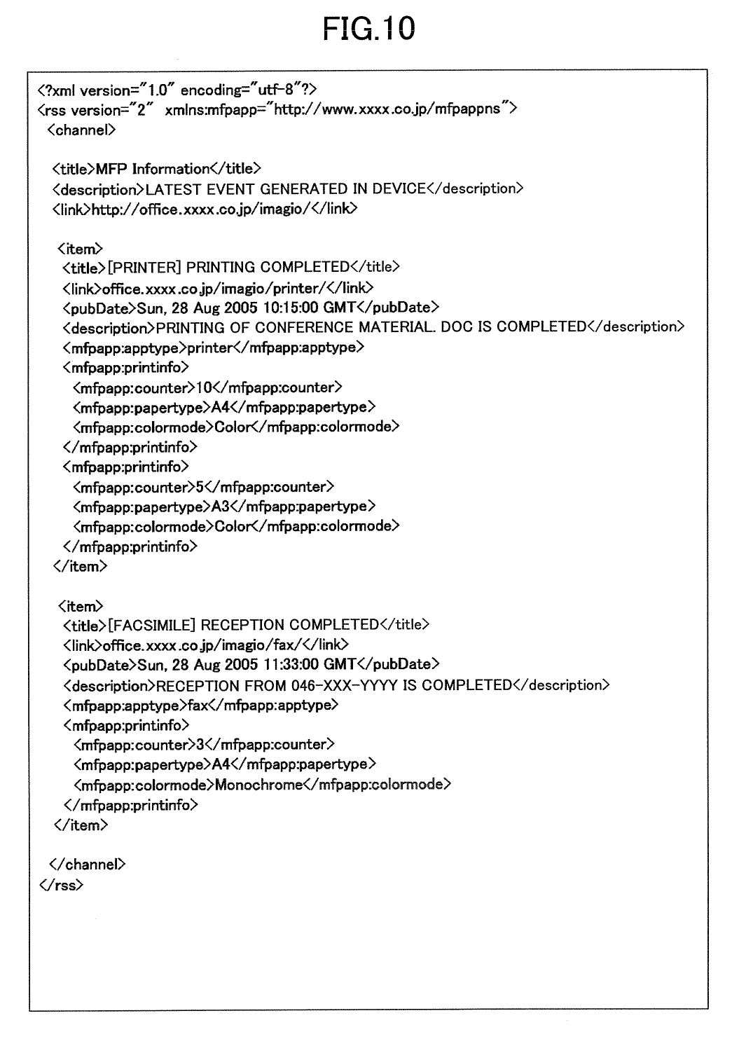

FIG. 10 is a schematic diagram showing an example of RSS data to which information on the number of print sheets, a paper size, and a print mode is added.

A structure of data in FIG. 10 is the same as in FIG. 5. In FIG. 10, tags for indicating print information (mfpapp:printinfo, mfpapp:papertype, and mfpapp:colormode in this case) are added in the name space.

Each set of tags indicates the print information, the paper size, or the print mode (color or monochrome). The example shows cases when a document is printed on a printer and when printing is performed upon receiving a facsimile message.

When the user receives RSS data in such a format as a response, it is possible to confirm the updated information on the device using software for processing RSS data.

Further, with the use of software capable of interpreting the tags for indicating the number of print sheets, the paper size, and the print mode defined in the unique name space, it is possible to judge the number of print sheets, the paper size, and the print mode in each entry of the updated information.

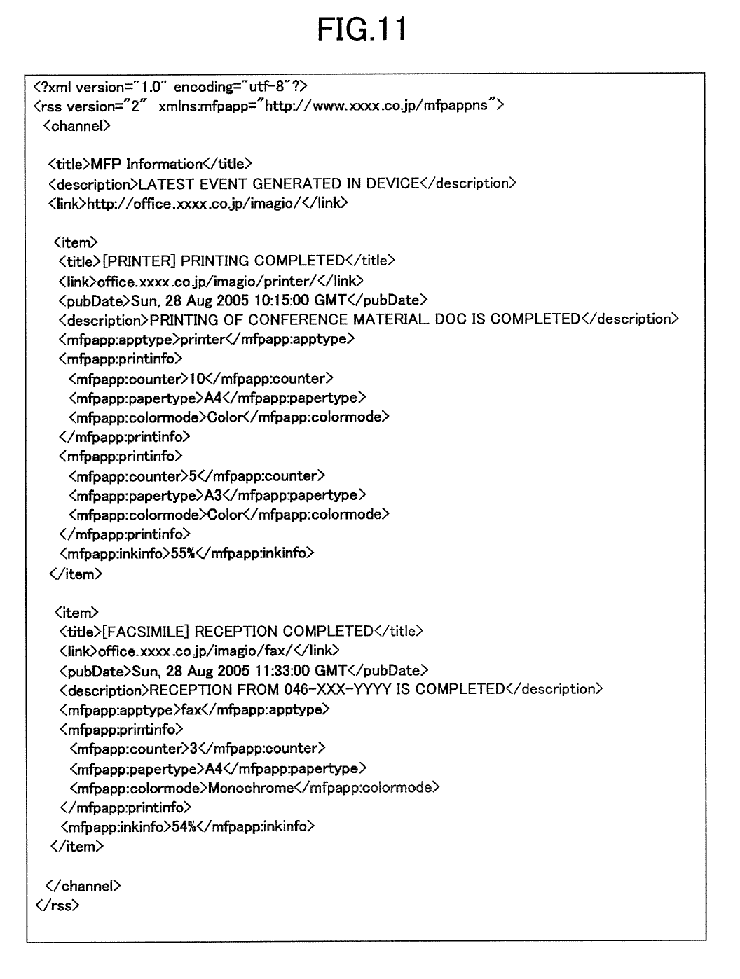

FIG. 11 is a schematic diagram showing an example of RSS data to which information on the number of print sheets, a paper size, a print mode, and a remaining amount of toner or ink is added.

A structure of data in FIG. 11 is the same as in FIG. 5. In FIG. 11, tags for indicating print information (mfpapp:printinfo, mfpapp:papertype, mfpapp:colormode, and mfpapp:inkinfo indicating information on the remaining amount of toner or ink, in this case) are added in the name space.

Each set of tags indicates the print information, the paper size, the print mode (color or monochrome), or the information on the remaining amount of toner or ink. The example shows cases when a document is printed on a printer and when printing is performed upon receiving a facsimile message.

When the user receives RSS data in such a format as a response, it is possible to confirm the updated information on the device using software for processing RSS data.

Further, with the use of software capable of interpreting the tags for indicating the number of print sheets, the paper size, the print mode, and information on the remaining amount of toner or ink defined in the unique name space, it is possible to judge the number of print sheets, the paper size, the print mode, and the remaining amount of toner or ink in each entry of the updated information.

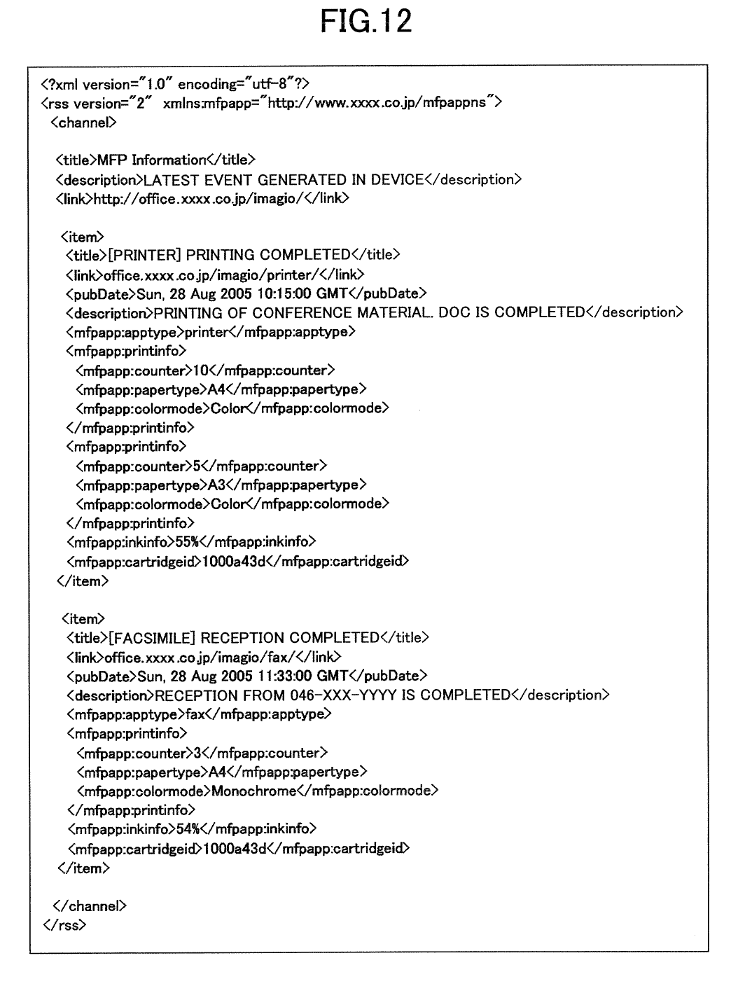

FIG. 12 is a schematic diagram showing an example of RSS data to which information on the number of print sheets, a paper size, a print mode, a remaining amount of toner or ink, and an ID number of a toner or ink cartridge is added.

A structure of data in FIG. 12 is the same as in FIG. 5. In FIG. 12, tags for indicating print information (mfpapp:printinfo, mfpapp:papertype, mfpapp:colormode, mfpapp:inkinfo indicating information on the remaining amount of toner or ink, and mfpapp:cartridgeid indicating information on an ID number of a toner or ink cartridge in this case) are added in the name space.

Each set of tags indicates the print information, the paper size, the print mode (color or monochrome), the information on the remaining amount of toner or ink, or the information on the ID number of the toner or ink cartridge. The example shows cases when a document is printed on a printer and when printing is performed upon receiving a facsimile message.

When the user receives RSS data in such a format as a response, it is possible to confirm the updated information on the device using software for processing RSS data.

Further, with the use of software capable of interpreting the tags for indicating the number of print sheets, the paper size, the print mode, the information on the remaining amount of toner or ink, and the information on the ID number of the toner or ink cartridge defined in the unique name space, it is possible to judge the number of print sheets, the paper size, the print mode, the remaining amount of toner or ink, and the ID number of the toner or ink cartridge in each entry of the updated information.

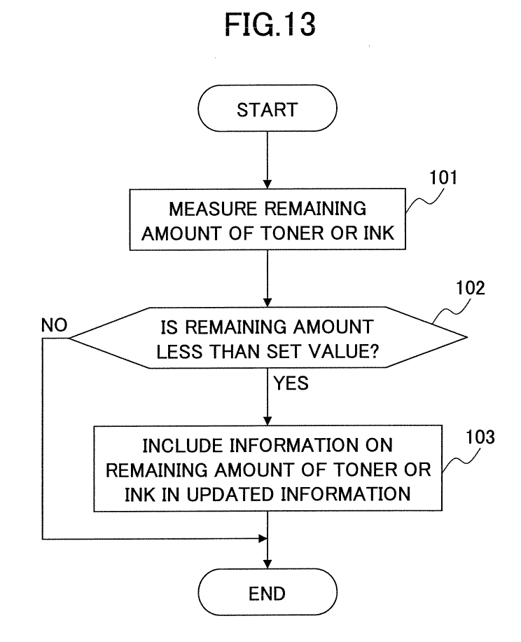

FIG. 13 is a flowchart showing a portion of processing for generating updated information on the device.

Upon performing the processing for generating updated information on the remaining amount of toner or ink, if the remaining amount of toner or ink of the device is not more than a set threshold value, information on the remaining amount of toner or ink is included in the updated information (processing 101, judgment 102, and processing 103). By contrast, if the remaining amount is more than the set threshold value, the information on the remaining amount of toner or ink is not output.

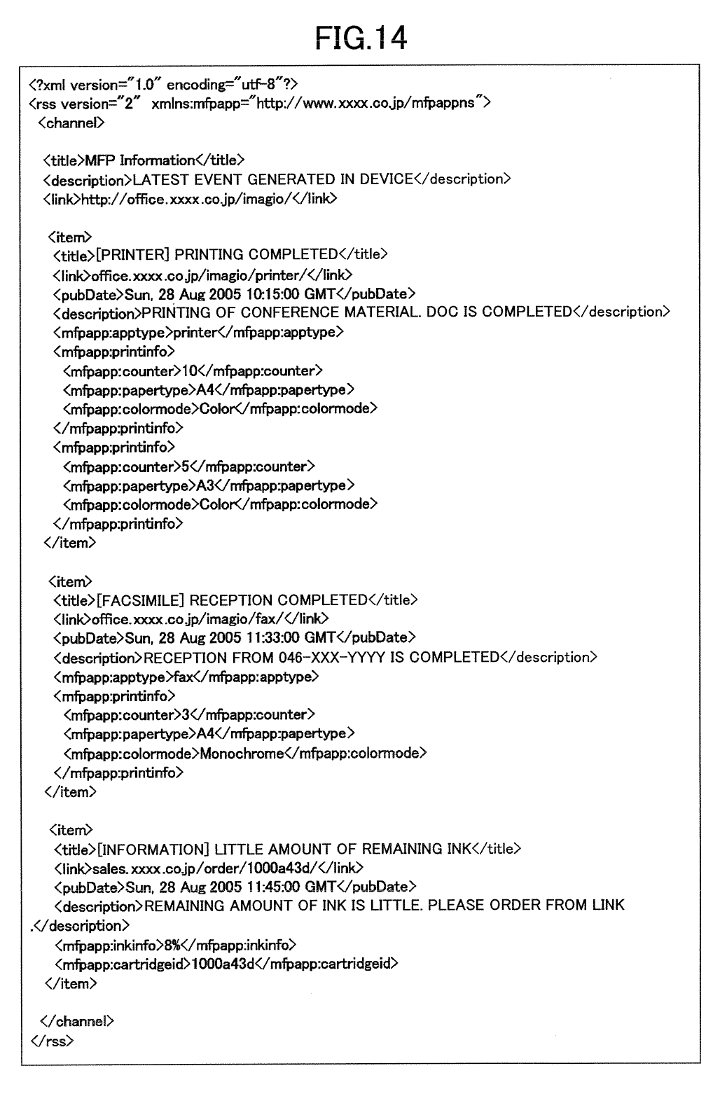

FIG. 14 is a schematic diagram showing an example of RSS data to which information on an ID number of a toner or ink cartridge is added.

A structure of data in FIG. 14 is the same as in FIG. 5. In FIG. 14, tags for indicating print information (mfpapp:printinfo, mfpapp:papertype, mfpapp:colormode, mfpapp:inkinfo indicating information on the remaining amount of toner or ink, and mfpapp:cartridgeid indicating information on the ID number of the toner or ink cartridge in this case) are added in the name space.

Each set of tags indicates the print information, the paper size, the print mode (color or monochrome), the information on the remaining amount of toner or ink, or the information on the ID number of the toner or ink cartridge. The example shows cases when a document is printed on a printer and when printing is performed upon receiving a facsimile message.

The information on the toner or ink cartridge is displayed in an entry separate from printing and facsimile reception in the example. In a link element, an address of a site where order placement for consumables is possible is set. The ID of the cartridge is added to the address in the link element shown in the figure. In the site where the order is placed, this information may be used so as to guide the user to an appropriate cartridge.

When the user receives RSS data in such a format as a response, it is possible to confirm the updated information on the device using software for processing RSS data.

Further, with the use of software capable of interpreting the tags for indicating the number of print sheets, the paper size, the print mode, the information on the remaining amount of toner or ink, and the information on the ID number of the toner or ink cartridge defined in the unique name space, it is possible to judge the number of print sheets, the paper size, the print mode, the remaining amount of toner or ink, and the ID number of the toner or ink cartridge in each entry of the updated information.

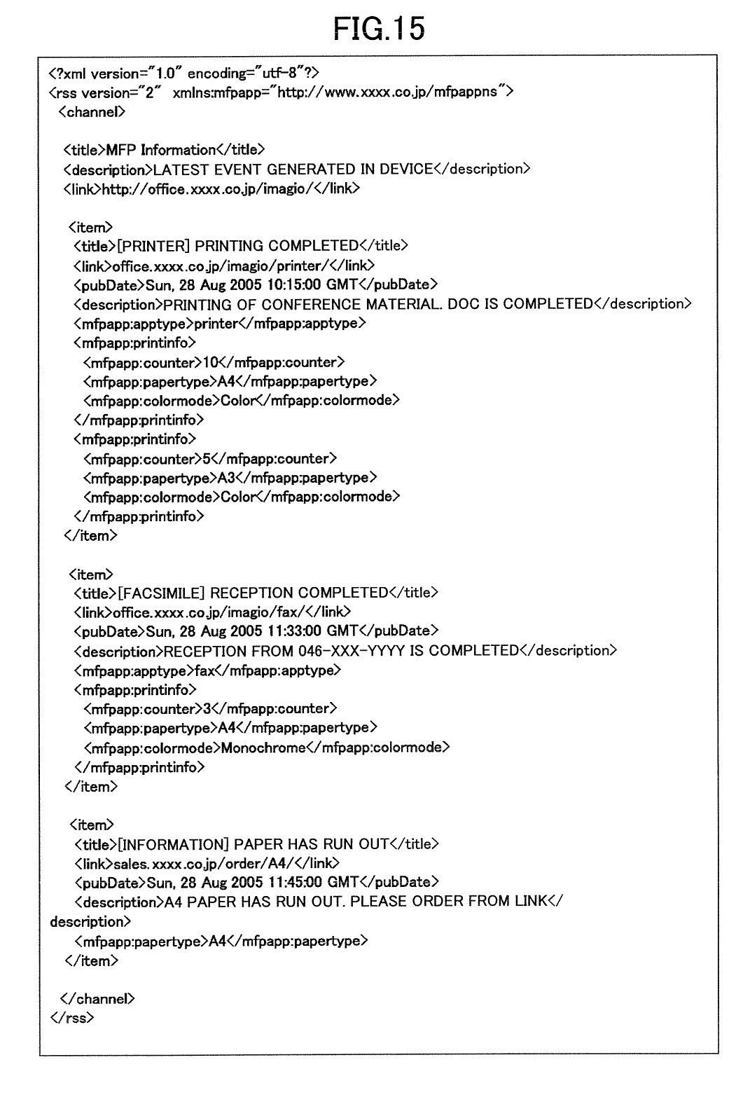

FIG. 15 is a schematic diagram showing an example of RSS data.

A structure of data in FIG. 15 is the same as in FIG. 5. In FIG. 15, tags for indicating print information (mfpapp:printinfo, mfpapp:papertype, and mfpapp:colormode, in this case) are added in the name space.

Each set of tags indicates the print information, the paper size, or the print mode (color or monochrome). The example shows cases when a document is printed on a printer and when printing is performed upon receiving a facsimile message.

Information for a case where paper runs out is displayed in an entry separate from printing and facsimile reception in the example. In a link element, an address of a site where order placement for consumables is possible is set. The paper size is added to the address in the link element shown in the figure. In the site where the order is placed, this information may be used so as to guide the user to an appropriate paper size.

When the user receives RSS data in such a format as a response, it is possible to confirm the updated information on the device using software for processing RSS data.

Further, with the use of software capable of interpreting the tags for indicating the number of print sheets, the paper size, and the print mode defined in the unique name space, it is possible to judge the number of print sheets, the paper size, and the print mode in each entry of the updated information.

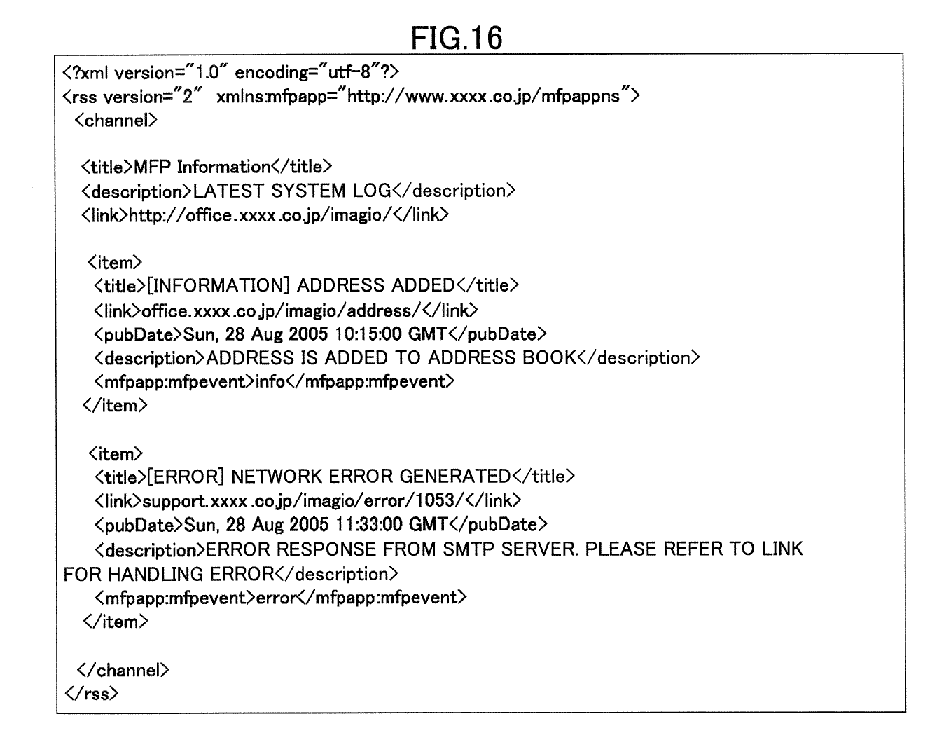

FIG. 16 is a schematic diagram showing an example of RSS data in which information is categorized into information, error, warning, and the like in terms of importance.

A structure of data in FIG. 16 is the same as in FIG. 5. In FIG. 16, tags for indicating importance of information (mfpapp:mfpevent in this case) are added in the name space.

When the user receives RSS data in such a format as a response, it is possible to confirm the updated information on the device using software for processing RSS data.

Further, with the use of software capable of interpreting the tags for indicating importance of information defined in the unique name space, it is possible to judge the importance of information in each entry of the updated information.

In an entry represented as a network error in the example, an address of a site that describes a handling method of the error is set in a link element. In a support site, this information may be used so as to guide the user to an appropriate handling method of the error.

As mentioned above, in the present embodiment, information by which applications can be distinguished is included in the updated information output by the device, so that it is possible to discriminate information on the device in each application.

Further, the tags for indicating the importance of information are added to each entry of the updated information output by the device, so that it is possible for the user to judge the importance of each entry and to perform appropriate processing on an important event.

Further, log information conventionally managed by the device is included in an RSS or Atom feed, so that it is possible to automatically confirm the information using feed reader software without means such as a web browser or dedicated application software that is usually employed so as to refer to such information.

Further, information on the number of print sheets is included in a feed entry, so that it is possible for the user to readily obtain the information on the number of print sheets.

Further, information on the size of print paper is included in an RSS or Atom feed entry, so that it is possible for the user to readily obtain the information on the size of print paper.

Further, information on the print mode (color printing or monochrome printing) is included in an RSS or Atom feed entry, so that it is possible for the user to readily obtain the information on the print mode.

Further, information on a remaining amount ink or toner is included in an RSS or Atom feed entry, so that it is possible for the user to readily obtain the information on the remaining amount of ink or toner.

Further, information on the ID of an ink or toner cartridge is included in an RSS or Atom feed entry, so that it is possible for the user to readily obtain information on a specific ink or toner cartridge.

Further, information on a remaining amount of an ink or toner cartridge is included in a feed entry only when the remaining amount of ink or toner becomes not more than a set value, so that it is possible for the user to more efficiently obtain the information on the remaining amount of the ink or toner cartridge.

Further, a link in an entry including information on a remaining amount of ink or toner is created as an address (URL) of a site where order placement for consumables is possible, so that it is possible for the user to more readily place an order for consumables such as ink, toner, and the like.

Further, a link in an entry including information on a case where paper runs out is created as an address of a site where order placement for consumables is possible, so that it is possible for the user to more readily place an order for paper.

Further, a link in an entry including information on an error generated in the device is created as an address of a site that describes a handling method of the error, so that it is possible for the user to more readily handle the error.

In addition, the above-mentioned embodiment is described based on the case where the present invention is applied to the network-enabled multi-function device constructed as shown in FIG. 1. However, it is possible to apply the present invention to communication terminal devices having other structure in the same manner.

The present invention is not limited to the specifically disclosed embodiment, and variations and modifications may be made without departing from the scope of the present invention.

The present application is based on Japanese priority application No. 2005-344797 filed Nov. 30, 2005, the entire contents of which are hereby incorporated herein by reference.

What is claimed is:

1. A communication terminal apparatus comprising:
a system control unit performing a plurality of device functions and a network communication function capable of communication via a network, wherein
usage history information regarding each of the plural device functions is modified and transmitted in a semantic XML document of a predetermined format.

2. The communication terminal apparatus according to claim 1, wherein
the usage history information includes importance of information.

3. The communication terminal apparatus according to claim 1, wherein
the usage history information includes information on consumables.

4. The communication terminal apparatus according to claim 2, wherein
the usage history information includes information on consumables.

5. The communication terminal apparatus according to claim 3, wherein
the information on consumables further includes contact information on an order destination for ordering relevant consumables.

6. The communication terminal apparatus according to claim 4, wherein
the information on consumables further includes contact information on an order destination for ordering relevant consumables.

7. The communication terminal apparatus according to claim 1, wherein
the usage history information further includes a URL for obtaining information for handling error information included in the usage history information.

8. The communication terminal apparatus according to claim 2, wherein
the usage history information further includes a URL for obtaining information for handling error information included in the usage history information.
